(19) United States
(12) Patent Application Publication
(10) Pub. No.: US 2024/0214872 A1
(43) Pub. Date: Jun. 27, 2024

(54) NETWORK MANAGEMENT SYSTEM, NETWORK MANAGEMENT METHOD AND PROGRAM

(71) Applicant: RAKUTEN MOBILE, INC., Tokyo (JP)

(72) Inventor: Jin NAKAZATO, Setagaya-ku, Tokyo (JP)

(21) Appl. No.: 17/906,739

(22) PCT Filed: Jun. 4, 2021
(86) PCT No.: PCT/JP2021/021458

§ 371 Date: Sep. 19, 2022

(51) Int. Cl. H04W 28/18; H04W 88/08

(52) U.S. Cl. CPC H04W 28/18; H04W 88/08

(57) ABSTRACT

A network management system configured to: transmit configuration information to a management server configured to manage a server group, the configuration information indicating a default function that implements a radio access network in cooperation with a base station and causing the management server to deploy a program that implements the default function in a part of the server group; acquire a communication performance indicating a communication status in radio communication between the base station and a plurality of user terminals; determine, based on the acquired communication performance, new configuration information indicating a configuration including a function that implements the radio access network in cooperation with the base station; and transmit the determined configuration information instead of the already deployed program that implements the default function.

### TECHNICAL FIELD

The present invention relates to a network management system, a network management method, and a program.

### BACKGROUND ART

In recent years, a virtual radio access network (vRAN) technology and an Open-RAN technology have been attracting attention. For example, at least a part of communication functions of controlling communication between a radio base station and a user terminal can be virtualized and processed by general-purpose servers. Hardware resources of the general-purpose servers are pooled in advance. When a new radio base station is added, a hardware resource is allocated to a communication function for the radio base station, and a general-purpose server to which the hardware resource is allocated implements the communication function.

### SUMMARY OF INVENTION

### Problem to be Solved

Under the present circumstances, even when the communication functions are virtualized, required hardware resources or a power consumption amount cannot be reduced much compared to a dedicated device. Accordingly, for example, a large number of general-purpose servers and a large amount of electric power are required in order to maintain a radio communication network formed of a plurality of radio base stations.

The present invention has been made in view of the above-mentioned problem, and an object thereof is to provide a technology capable of reducing hardware resources or a power consumption amount required for controlling a radio base station.

### Solution to Problem

In order to solve the above-mentioned problem, according to one embodiment of the present invention, there is provided a network management system including: a deployment control unit configured to transmit configuration information to a management server configured to manage a server group configured to execute a virtualized and deployed program, the configuration information indicating a default function that implements a radio access network in cooperation with a base station and causing the management server to deploy a program that implements the default function in a part of the server group; a performance acquisition unit configured to acquire a communication performance indicating a communication status in radio communication between the base station and a plurality of user terminals; and a configuration determination unit configured to determine, based on the acquired communication performance, new configuration information indicating a configuration including a function that implements the radio access network in cooperation with the base station, wherein the deployment control unit is configured to transmit the determined configuration information which cause the management server to deploy, instead of the already deployed program that implements the default function, a program indicated by the determined configuration information in a part of the server group.

Further, according to one embodiment of the present invention, there is provided a network management method including the steps of: transmitting configuration information to a management server configured to manage a server group configured to execute a virtualized and deployed program, the configuration information indicating a default function that implements a radio access network in cooperation with a base station and causing the management server to deploy a program that implements the default function in a part of the server group; acquiring a communication performance indicating a communication status in radio communication between the base station and a plurality of user terminals; determining, based on the acquired communication performance, new configuration information indicating a configuration including a function that implements the radio access network in cooperation with the base station; and transmitting the determined configuration information which cause the management server to deploy, instead of the already deployed program that implements the default function, a program indicated by the determined configuration information in a part of the server group.

Further, according to one embodiment of the present invention, there is provided a program for causing a computer to function as: a deployment control unit configured to transmit configuration information to a management server configured to manage a server group configured to execute a virtualized and deployed program, the configuration information indicating a default function that implements a radio access network in cooperation with a base station and causing the management server to deploy a program that implements the default function in a part of the server group; a performance acquisition unit configured to acquire a communication performance indicating a communication status in radio communication between the base station and a plurality of user terminals; and a configuration determination unit configured to determine, based on the acquired communication performance, new configuration information indicating a configuration including a function that implements the radio access network in cooperation with the base station. The deployment control unit is configured to transmit the determined configuration information which cause the management server to deploy, instead of the already deployed program that implements the default function, a program indicated by the determined configuration information in a part of the server group.

In one embodiment of the present invention, the communication performance may indicate a status of congestion in the radio communication between the base station and the plurality of user terminals.

In one embodiment of the present invention, the communication performance may include information indicating a state of a radio communication channel between the base station and the plurality of user terminals.

In one embodiment of the present invention, the communication performance may include a number of the plurality of user terminals that have performed the radio communication to/from the base station.

In one embodiment of the present invention, the deployment control unit may be configured to transmit resource information together with the configuration information, the resource information indicating a hardware resource to be allocated by the management server for execution of the program indicated by the configuration information.

In one embodiment of the present invention, the configuration determination unit may be configured to select, based on the acquired communication performance, one piece of configuration information as the determined configuration information from among a plurality of pieces of configuration information each including any function of a beamforming control function, a plurality of MIMO control functions having mutually different numbers of layers, or an SISO control function.

In one embodiment of the present invention, the configuration determination unit may be configured to determine new configuration information that implements the radio access network in cooperation with the base station based on the acquired communication performance and information indicating quality requirements of the base station.

### Advantageous Effects of Invention

According to the present invention, it is possible to reduce the hardware resources or the power consumption amount required for controlling the radio base station.

### BRIEF DESCRIPTION OF DRAWINGS

FIG. 1 is a diagram for illustrating an example of a network system according to an embodiment of the present invention.

FIG. 2 is a block diagram for illustrating an example of functions implemented by a network management system.

FIG. 3 is a diagram for illustrating relationships among the functions in a radio access network.

FIG. 4 is a sequence diagram for illustrating a process relating to deployment of functions of controlling a base station.

FIG. 5 is a flow chart for illustrating an example of a process of the network management system.

FIG. 6 is a table for showing an example of catalog selection information for selection of configuration information.

FIG. 7 is a table for showing an example of relationships between pieces of configuration information and functions.

### DESCRIPTION OF EMBODIMENTS

Now, an embodiment of the present invention is described with reference to the accompanying drawings. Duplicate descriptions are omitted for components denoted by the same reference numerals.

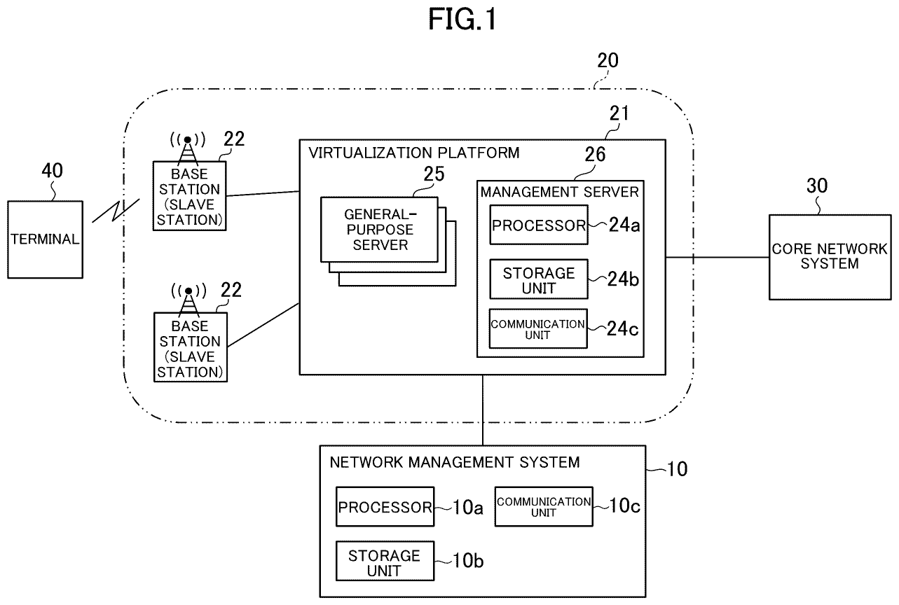

FIG. 1 is a diagram for illustrating an example of a network system according to the embodiment of the present invention. The network system is a system for implementing a mobile communication system. The network system includes a network management system 10, a radio access network 20, a core network system 30, and a user terminal 40.

The core network system 30 is a system corresponding to an evolved packet core (EPC) in a fourth generation mobile communication system (hereinafter referred to as “4G”) or a 5G core network (5GC) including an access and mobility management function (AMF), a session management function (SMF), a user plane function (UPF), and the like in a fifth generation mobile communication system (hereinafter referred to as “5G”). The core network system 30 provides a gateway for connecting the radio access network 20 to the Internet or the like, and also controls communication and billing depending on a user. The core network system 30 in this embodiment is implemented by a group of servers arranged in a plurality of data centers provided at various locations.

The radio access network (RAN) 20 corresponds to an eNodeB (eNB) in 4G and an NR base station (gNB) in 5G, and provides radio communication to connect the user terminal 40 and the core network system 30 to each other. The radio access network 20 physically includes: a plurality of base stations 22 (also referred to as “slave stations”) each including an antenna and corresponding to an RU in 5G; and a virtualization platform 21. The virtualization platform 21 includes: a server group formed of a plurality of general-purpose servers 25; and a management server 26. The management server 26 includes a processor 24a, a storage unit 24b, and a communication unit 24c.

The processor 24a is a microprocessor or another program control device which operates in accordance with a program stored in the storage unit 24b. The above-mentioned program may be provided through the Internet or the like, or may be provided by being stored in a computer-readable storage medium such as a flash memory or DVD-ROM. The storage unit 24b is, for example, a storage element such as a ROM or RAM or an external storage device such as a solid state drive (SSD) or hard disk drive (HDD). The storage unit 24b stores a program to be executed by the processor 24a, results of processes, input data, and the like. The communication unit 24c is, for example, a communication interface, for example, a network interface card (NIC).

The virtualization platform 21 provides functions of a virtual DU (vDU) and a virtual CU (vCU) in 4G and a DU and a CU in 5G. The vDU and DU (hereinafter referred to collectively as “DU”) process a signal received from the base station 22, and the vCU and CU (hereinafter referred to collectively as “CU”) process a signal received from the DU, and output a process result to the core network system 30. The virtualization platform 21 is arranged in one or a plurality of data centers. A data center in which one or a plurality of servers that implement a DU are arranged and a data center in which one or a plurality of servers that implement a CU are arranged may be the same or may be different from each other.

The network management system 10 manages the radio access network 20. More specifically, the network management system 10 manages the functions implemented by the virtualization platform 21 in cooperation with the base stations 22. The network management system 10 includes one or a plurality of processors 10a, one or a plurality of storage units 10b, and one or a plurality of communication units 10c. The network management system 10 may be formed of one or a plurality of servers.

The processor 10a is a microprocessor or another program control device which operates in accordance with a program stored in the storage unit 10b. The above-mentioned program may be provided through the Internet or the like, or may be provided by being stored in a computer-readable storage medium such as a flash memory or DVD-ROM. The storage unit 10b is, for example, a storage element such as a ROM or RAM or an external storage device such as a solid state drive (SSD) or hard disk drive (HDD). The storage unit 10b stores a program to be executed by the processor 10a, results of processes, input data, and the like. The communication unit 10c is, for example, a communication interface such as a network interface card (NIC).

In this embodiment, the virtualization platform 21 provides the functions of the DU and CU in a radio access network. The DU and CU are created by virtualization technology as, for example, images of containers or virtual machines. The general-purpose server 25 executes an application for providing an execution environment, and executes a container or virtual machine on the application, to thereby provide the functions of the DU and CU. In the virtualization technology, the general-purpose server 25 which executes the container or virtual machine is not fixed in advance, and the management server 26 executes, as a management, controlling which general-purpose server 25 the image is to be deployed to, execution control of functions included in the image, and the like. A management tool such as Kubernetes or OpenStack Controller is installed and put in operation on the management server 26 for management thereof.

The network management system 10 manages the radio access network 20 by automatically performing, on the management server 26, various settings for executing the functions of the DU and CU on the virtualization platform 21. The automatic performing of various settings is also called “orchestration.”

The management of the radio access network 20 performed mainly by the network management system 10 is described below in more detail.

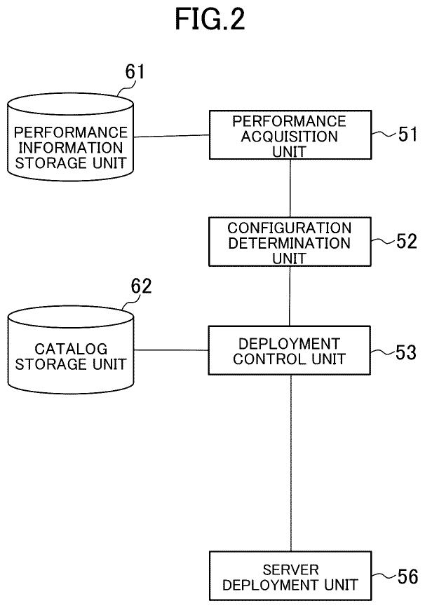

FIG. 2 is a block diagram for illustrating an example of functions implemented by the network management system 10 and the management server 26. FIG. 2 does not include an illustration of the functions provided by the general-purpose server 25 executing images deployed by the network management system 10 and the management server 26.

The network management system 10 functionally includes a performance acquisition unit 51, a configuration determination unit 52, a deployment control unit 53, a performance information storage unit 61, and a catalog storage unit 62. Functions of the performance acquisition unit 51, the configuration determination unit 52, and the deployment control unit 53 are each implemented by the processor 10a executing a program stored in the storage unit 10b and controlling the communication unit 10c and the like. The management server 26 functionally includes a server deployment unit 56. A function of the server deployment unit 56 is implemented by the processor 24a executing a program stored in the storage unit 24b and controlling the communication unit 24c and the like.

The performance information storage unit 61 and the catalog storage unit 62 are implemented mainly by the storage unit 10b. A communication performance is stored in the performance information storage unit 61. The catalog storage unit 62 stores CU and DU images that can be deployed in the general-purpose server 25 through intermediation of the management server 26. In the following description, the images stored in the catalog storage unit 62 are also referred to as “catalogs.” The catalog storage unit 62 may be implemented by software for managing images stored in the storage unit 10b, for example, Glance in OpenStack.

The performance acquisition unit 51 acquires a communication performance indicating a communication status in radio communication between the base station 22 and the plurality of user terminals 40.

The communication performance includes information indicating the number of user terminals 40 accessing the base station 22 and information indicating the status of congestion in the radio communication between the base station 22 and the plurality of user terminals 40. The information indicating the status of congestion in the radio communication may include at least one of information indicating the state of a radio communication channel or the number of the plurality of user terminals 40 (hereinafter referred to as “the number of users”) that have performed radio communication to/from the base station 22.

The information indicating the state of the radio communication channel may be, for example, context information defined by 3GPP or channel state information (CSI). The context information is information detected on the user terminal 40 side, and includes the state of the radio wave relevant to the connection destination base station 22 and a handover destination radio section. The information indicating the state of the radio communication channel may be a correlation between users (also referred to as “correlation between antennas” or “propagation path correlation”), or may be information indicating an S/N ratio calculated by the base station 22. A high correlation between users corresponds to an urban area, and is an index that affects a gain in beamforming and the number of multi-layers of MIMO.

The context information and channel state information are transmitted from the user terminal 40 to the base station 22, and are temporarily stored in the base station 22. The number of users may be temporarily stored in the base station 22. For example, the performance acquisition unit 51 of the network management system 10 periodically acquires information stored in the base station 22, and stores the information in the performance information storage unit 61.

The configuration determination unit 52 determines new configuration information indicating a configuration including a function that implements a radio access network in cooperation with the base station 22 based on the acquired communication performance.

The deployment control unit 53 transmits the configuration information indicating a default function that implements a radio access network in cooperation with the base station 22 to the management server for managing the plurality of general-purpose servers 25 each configured to execute a virtualized and deployed program. The configuration information is information for causing the management server 26 to deploy a program that implements those functions in a part of the plurality of general-purpose servers 25. The deployment control unit 53 also transmits the configuration information determined by the configuration determination unit 52 to the management server 26 instead of the already deployed program. The configuration information is information for causing the management server 26 to deploy a program that implements the functions in a part of the plurality of general-purpose servers 25.

The server deployment unit 56 deploys a program corresponding to the configuration information in a part of the plurality of general-purpose servers 25 based on the configuration information received from the deployment control unit 53. The program corresponding to the configuration information serves to implement the functions of the radio access network 20, and the functions to be implemented differ depending on the configuration information.

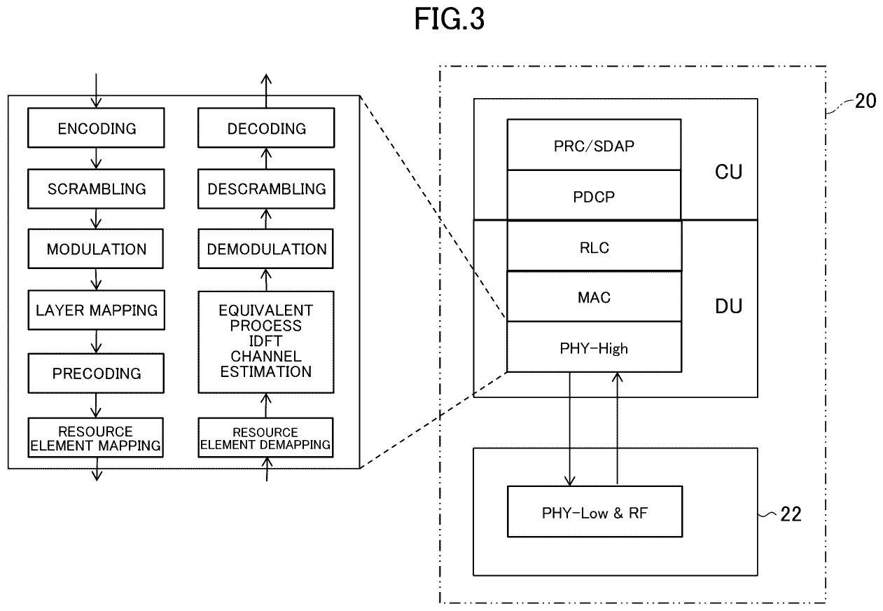

In this embodiment, the functions to be deployed on the virtualization platform 21 differ depending on the communication performance between the base station 22 and the user terminal 40. FIG. 3 is a diagram for illustrating relationships among the functions in the radio access network 20.

A device (RU) that implements the function of PHY-Low & RF is arranged in the base station 22. The functions of the DU deployed on the virtualization platform 21 include functions, for example, PHY-High being a function closer to the physical layer, MAC, and RLC. In addition, the functions of the CU deployed on the virtualization platform 21 include functions of PDCP and PRC/SDAP functions. The PHY-High also includes functions involved in the control of radio communication in the base station 22. On the left side of FIG. 3, further subdivided functions of the PHY-High function are illustrated. Of the functions included in PHY-High, the functions that require significantly different hardware resources depending on the control method are “modulation,” “demodulation,” “layer mapping,” and “beamforming” which is not directly illustrated. In addition, in regard to encoding functions such as diversity and diffusion code, it is also possible to optimize the required hardware resources and power consumption by changing the control method. The functions that involve a change in the hardware resources are subjected to selection or deselection in the configuration information described below.

There are 16QAM, 256QAM, and the like as the “modulation” and “demodulation” methods. The “layer mapping” is a function involved in multiplexing in so-called MIMO, and the processing load and required hardware resources are greatly changed depending on the number of layers of MIMO, more specifically, which of, for example, 2-Layer MIMO, 4-Layer MIMO, or Massive MIMO is employed. Further, in the case of using SISO instead of MIMO, the required hardware resources are significantly reduced. The beamforming is a function of controlling an array antenna to control directivity so as to obtain an advantage in transmission and reception to/from the user terminal 40.

Hitherto, when the base station 22 is installed, the required functions have been manually selected, and all the functions of the CU and DU have been deployed in the general-purpose servers 25 in the virtualization platform 21. In this embodiment, first, all the functions are deployed in the same manner. Meanwhile, after that, depending on the communication performance, for example, the beamforming is eliminated and the number of layers (multiplicity) of MIMO is reduced, to thereby deploy only more suitable functions on the virtualization platform 21. Then, it is not required to allocate cores and other hardware resources and computational resources to functions that are less required, and hence usage amounts of hardware resources and power consumption can be optimized. Accordingly, it can be expected to reduce the total usage amounts of hardware resources and power consumption.

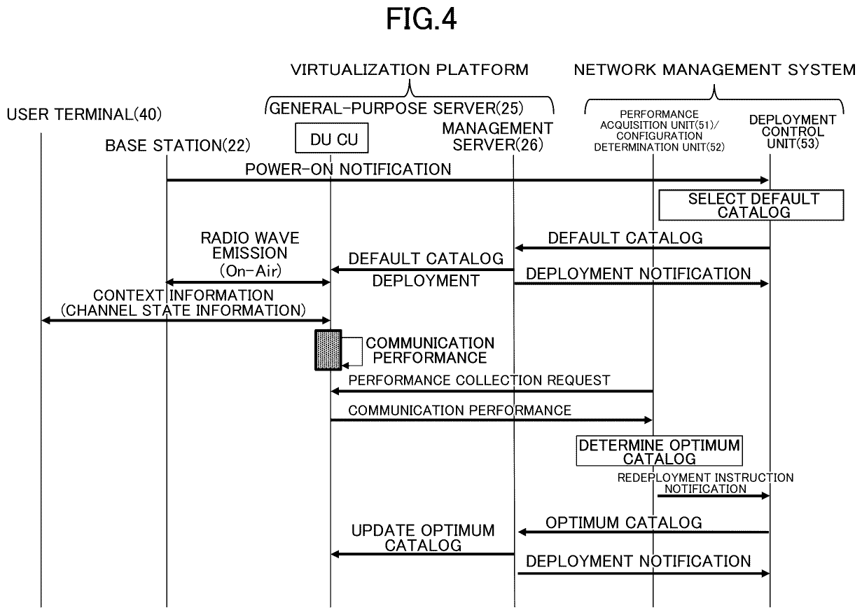

Next, details of a process of the network management system 10 is described. FIG. 4 is a sequence diagram for illustrating a process relating to the deployment of functions of controlling the base station 22. FIG. 4 is an illustration of a flow of deployment of a first-time default catalog involved in the installation of the base station 22 and deployment of the next catalog corresponding to a communication performance obtained thereafter.

First, when the base station 22 is physically installed and powered on for the first time, the base station 22 transmits a power-on notification to the network management system 10. When the deployment control unit 53 receives the power-on notification from the base station 22, the deployment control unit 53 selects a default catalog as the configuration information for providing the initial functions of the DU and CU that operate in cooperation with the base station 22. The default catalog is an image file that implements full functionality. Then, the deployment control unit 53 registers the default catalog for cooperation with the base station 22 in the management server 26 by transmitting the default catalog to the management server 26 as the configuration information. In this case, the deployment control unit 53 also transmits, together with the catalog, information (resource information) on hardware resources (number of cores and memory) required for processing each of functions included in the image of the catalog.

The management server 26 (server deployment unit 56) in which the default catalog is registered determines, based on the resource information, a hardware resource (allocates the hardware resource) for executing the program of the default catalog from among the hardware resources of the plurality of general-purpose servers 25 which are registered as free resources in a resource pool in advance, the management server 26 deploys the image of the default catalog in the general-purpose server 25 including the determined hardware resource, and causes the general-purpose server 25 to execute the program for implementing the default functions of the DU and CU included in the deployed image. Thus, the base station 22 emits radio waves, and this base station 22 starts operating as a part of the radio access network 20. Then, the management server 26 transmits a deployment notification indicating that the deployment has been completed to the deployment control unit 53.

The base station 22 also performs radio communication to/from the user terminal 40, and the general-purpose server 25 that implements the functions of the DU temporarily stores the context information or channel state information obtained during the process. The general-purpose server 25 that implements the functions of the DU may temporarily store information indicating the number of users and the S/N ratio as the communication performance. This general-purpose server 25 may periodically acquire and store the communication performance of those pieces of information. FIG. 4 includes an illustration of only one time of transmission and reception regarding the context information or channel state information, but in actuality, a plurality of times of transmission and reception are performed.

The performance acquisition unit 51 periodically transmits a performance collection request to the general-purpose server 25 that implements the DU, and receives, in response thereto, a plurality of pieces of communication performance temporarily stored from the general-purpose server 25. The performance acquisition unit 51 stores the received communication performance in the performance information storage unit 61. FIG. 4 includes an illustration of only one round trip of the transmission of the performance collection request and the reception of the communication performance, but in actuality, a plurality of round trips may be performed before the subsequent processes.

When a condition for updating the configuration is satisfied, for example, when a certain period of time has elapsed since the previous catalog deployment, the performance acquisition unit 51 acquires the communication performance from one or both of the performance information storage unit 61 and the general-purpose server 25, determines an optimum catalog from among the catalogs stored in the catalog storage unit 62, and instructs the deployment control unit 53 to perform redeployment. The deployment control unit 53 registers, based on the instruction, the optimum catalog for cooperation with the base station 22 in the management server 26 by transmitting the determined catalog to the management server 26 as the configuration information. The deployment control unit 53 transmits, together with the optimum catalog, information (resource information) of hardware resources (number of cores and memory) required for performing processes.

The management server 26 (server deployment unit 56) in which the optimum catalog is registered updates the already deployed catalog to the optimum catalog. More specifically, the server deployment unit 56 stops and deletes the program of the already deployed catalog, and releases the hardware resource allocated to that catalog. Further, the management server 26 determines, based on the resource information, a hardware resource (allocates the hardware resource) for executing the program of the optimum catalog from among the hardware resources of the plurality of general-purpose servers 25 which are registered as free resources in the resource pool in advance. The management server 26 deploys the image of the optimum catalog in the general-purpose server 25 including the determined hardware resource, and causes the general-purpose server 25 to execute the program for implementing the default functions of the DU and CU included in the deployed image. Then, the management server 26 transmits a deployment notification indicating that the deployment has been completed to the deployment control unit 53.

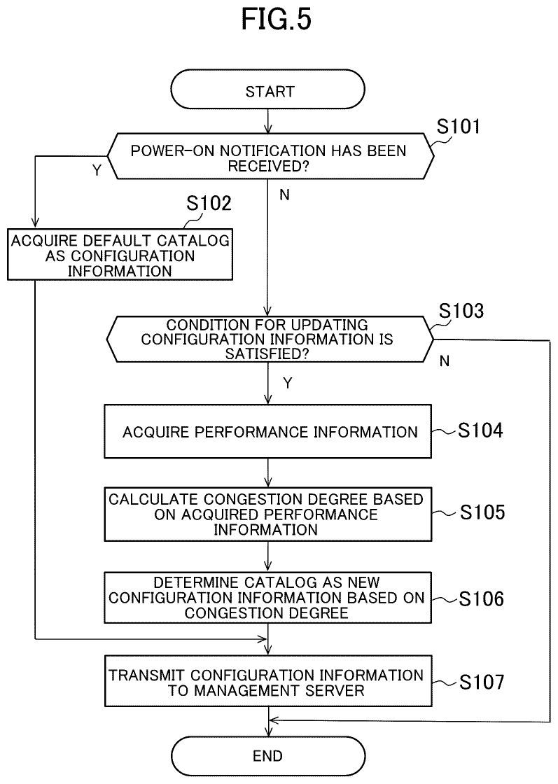

The process relating to the determination of the optimum catalog and the transmission of the optimum catalog is described in more detail. FIG. 5 is a flow chart for illustrating an example of a process of the network management system 10. The process illustrated in FIG. 5 is executed at a timing at which a power-on notification is received or periodically at night for each of the base stations 22.

First, the deployment control unit 53 determines whether or not a power-on notification has been received from the base station 22 (Step S101). When the power-on notification is received (Y in Step S101), the deployment control unit 53 acquires a default catalog as the configuration information from the catalog storage unit 62 for the base station 22 (Step S102). Then, the deployment control unit 53 transmits the configuration information to the management server (Step S107).

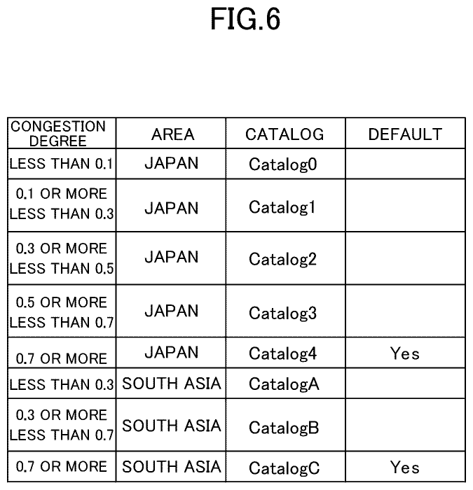

FIG. 6 is a table for showing an example of catalog selection information for selecting the configuration information. The catalog selection information may be stored in the catalog storage unit 62. The catalog selection information is set for each catalog. The catalog selection information is information linking a range of a congestion degree, an area, and whether or not the catalog is default, which are pieces of information to be used as conditions for the selection, to the catalog being the configuration information. In Step S107, the deployment control unit 53 selects the catalog linked to the area in which the base station 22 is located and “Yes” in “DEFAULT,” and acquires the selected catalog from the catalog storage unit 62 as the configuration information.

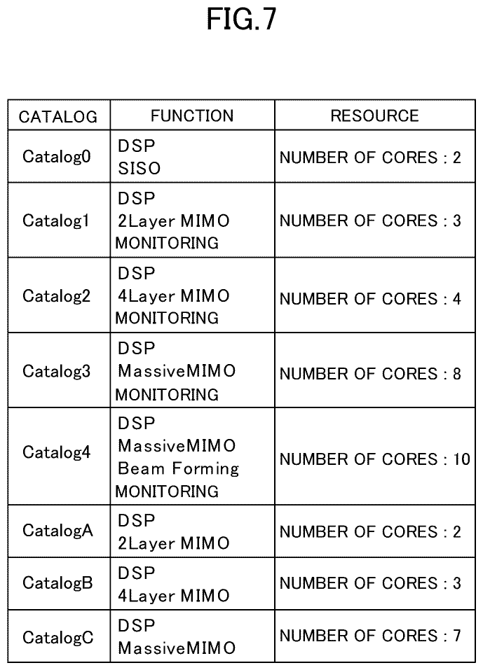

FIG. 7 is a table for showing an example of relationships between pieces of configuration information and functions. For each of the catalogs, the functions included in the catalog and the required hardware resources are shown. To simplify the description, FIG. 7 shows functions that are likely to be selected or deselected, mainly functions involved in MIMO and beamforming, and a monitoring function, but in actuality, each of the catalogs also includes other functions.

When base station 22 is located in Japan, in the example of FIG. 6, Catalog4 is selected as the default catalog, but as can be seen from FIG. 7 that Catalog4 is the most enhanced in functionality, and requires the most hardware resources.

Meanwhile, when a power-on notification has not been received from the base station 22, the deployment control unit 53 determines whether or not the condition for updating the configuration information for the base station 22 is satisfied (Step S103). This condition may be, for example, that a first period (for example, one week) has elapsed since the transmission of the default configuration information or that a second period (for example, one month) being a longer period has elapsed since the previous transmission of the configuration information. When the condition for updating the configuration information is not satisfied (N in Step S103), the process of FIG. 5 is ended.

When the condition for updating the configuration information is satisfied (Y in Step S103), the performance acquisition unit 51 acquires communication performance (performance information) from the performance information storage unit 61 (Step S104). The performance acquisition unit 51 may further acquire the latest (for example, the last one day) performance information by transmitting a performance collection request to the general-purpose server 25 that implements the DU.

Then, the configuration determination unit 52 calculates the congestion degree based on the acquired performance information (Step S105). The congestion degree is a numerical value of the status of congestion in the radio communication between the target base station 22 and the plurality of user terminals 40. For example, the configuration determination unit 52 multiplies each of the number of users, the correlation between users included in the information indicating a channel state, and the S/N ratio by a weighting factor corresponding to the item, and adds up the multiplied items. Then, the configuration determination unit 52 may acquire, as the congestion degree, a value normalized so that the minimum value and maximum value of the added values are 0 and 1, respectively.

Then, the configuration determination unit 52 determines a catalog as new configuration information for the base station 22 based on the calculated congestion degree (Step S106). More specifically, the configuration determination unit 52 selects, based on the catalog selection information shown in FIG. 6, a catalog linked to the area in which the base station 22 is located and the congestion degree that falls within the range, and determines the selected catalog as new configuration information.

As shown in FIG. 7, depending on the congestion degree, the catalog is changed in which one of a plurality of MIMO control functions having mutually different numbers of layers and an SISO control function is included. In addition, whether or not a beamforming control function is included is changed depending on the catalog. Thus, the required hardware resources (the number of cores of FIG. 7) are changed depending on the congestion degree.

In the examples of FIG. 6 and FIG. 7, when the base station 22 is located in Japan and the congestion degree is 0.4 due to the base station 22 being located in the suburbs with low congestion, Catalog2 is determined as the configuration information. In this case, even with the functions included in Catalog2, the actual performance does not change much. The hardware resources required for Catalog 2 are reduced compared to the hardware resources required for the default Catalog4, and the hardware resources used for the entire virtualization platform 21 are also reduced. When a required processing amount has changed due to the selection or deselection of functions, it is not required to change the required hardware resources such as the number of cores and memory. Even in such a case, a power usage amount can be reduced by reducing the processing amount. The catalog may be selected based on more parameters as well as the congestion degree. For example, when a correlative congestion degree between users is large, the multi-layer MIMO becomes difficult, and hence a catalog having a reduced maximum number of layers of MIMO may be selected.

In addition, the configuration information is changed depending on the area in which the base station 22 is arranged, to thereby enable optimization conforming to, for example, quality requirements of the area, and enable the reduction of the required hardware resources or power usage amount. For example, in an area in which SLA is set low, the monitoring function is reduced, to thereby enable the reduction of the required hardware resources or the like. When the requested quality requirements for each base station 22 dynamically change, the catalog may be selected based on the requested quality requirements instead of the area.

When the configuration information is determined by the configuration determination unit 52, the deployment control unit 53 transmits the determined configuration information to the management server 26 (Step S107). Thus, the server deployment unit 56 of the management server 26 deploys the image of the configuration information to a part of the plurality of general-purpose servers 25, and causes the part of the plurality of general-purpose servers 25 to provide the functions included in the configuration information.

The embodiment of the present invention has been described, but an embodiment to which the present invention is applicable is not necessarily limited to this embodiment. For example, when the image of the catalog that cooperates with the base station 22 is divided into a plurality of parts such as the CU and DU, the configuration determination unit 52 and the deployment control unit 53 are not required to determine and transmit the catalog based on the communication performance for a part of a plurality of catalogs. For example, the configuration determination unit 52 may simply determine the catalog of only the DU, and the deployment control unit 53 may transmit the catalog of only the DU as configuration information. In regard to the CU, the same CU may be used irrespective of the communication performance, and the CU may be excluded from the update target.

1. A network management system, comprising:
at least one processor; and
at least one memory device that stores a plurality of instructions which, when executed by the at least one processor, causes the at least one processor to:
transmit configuration information to a management server configured to manage a server group configured to execute a virtualized and deployed program, the configuration information indicating a default function that implements a radio access network in cooperation with a base station and causing the management server to deploy a program that implements the default function in a part of the server group;
acquire a communication performance indicating a communication status in radio communication between the base station and a plurality of user terminals;
determine, based on the acquired communication performance, new configuration information indicating a configuration including a function that implements the radio access network in cooperation with the base station; and
transmit the determined configuration information which cause the management server to deploy, instead of the already deployed program that implements the default function, a program indicated by the determined configuration information in a part of the server group.

2. The network management system according to claim 1, wherein the communication performance indicates a status of congestion in the radio communication between the base station and the plurality of user terminals.

3. The network management system according to claim 2, wherein the communication performance includes information indicating a state of a radio communication channel between the base station and the plurality of user terminals.

4. The network management system according to claim 2, wherein the communication performance includes a number of the plurality of user terminals that have performed the radio communication to/from the base station.

5. The network management system according to claim 1, wherein the plurality of instructions cause the at least one processor to transmit resource information together with the configuration information, the resource information indicating a hardware resource to be allocated by the management server for execution of the program indicated by the configuration information.

6. The network management system according to claim 1, wherein the plurality of instructions cause the at least one processor to select, based on the acquired communication performance, one piece of configuration information as the determined configuration information from among a plurality of pieces of configuration information each including any function of a beamforming control function, a plurality of MIMO control functions having mutually different numbers of layers, or an SISO control function.

7. The network management system according to claim 1, wherein the plurality of instructions cause the at least one processor to determine new configuration information that implements the radio access network in cooperation with the base station based on the acquired communication performance and information indicating quality requirements of the base station.

8. A network management method, comprising the steps of:
transmitting, with at least one processor operating with a memory device in a system, configuration information to a management server configured to manage a server group configured to execute a virtualized and deployed program, the configuration information indicating a default function that implements a radio access network in cooperation with a base station and causing the management server to deploy a program that implements the default function in a part of the server group;
acquiring, with the at least one processor operating with the memory device in the system, a communication performance indicating a communication status in radio communication between the base station and a plurality of user terminals;
determining, based on the acquired communication performance, new configuration information indicating a configuration including a function that implements the radio access network in cooperation with the base station with the at least one processor operating with the memory device in the system; and
transmitting, with the at least one processor operating with the memory device in the system, the determined configuration information to cause the management server to deploy, instead of the already deployed program that implements the default function, the determined configuration information, a program indicated by the determined configuration information in a part of the server group.

9. A non-transitory computer readable storage medium storing a plurality of instructions, wherein when executed by at least one processor, the plurality of instructions cause the at least one processor to:
transmit configuration information to a management server configured to manage a server group configured to execute a virtualized and deployed program, the configuration information indicating a default function that implements a radio access network in cooperation with a base station and causing the management server to deploy a program that implements the default function in a part of the server group;
acquire a communication performance indicating a communication status in radio communication between the base station and a plurality of user terminals;
determine, based on the acquired communication performance, new configuration information indicating a configuration including a function that implements the radio access network in cooperation with the base station; and
transmit the determined configuration information to cause the management server to deploy, instead of the already deployed program that implements the default function, a program indicated by the determined configuration information in a part of the server group.
